(19) United States
(12) Patent Application Publication
(10) Pub. No.: US 2006/0088397 A1
(43) Pub. Date: Apr. 27, 2006

(54) Hydraulic lift box cover for flatbed trucks

(76) Inventor: Harold Dorris, Hayward, CA (US)

Correspondence Address: Donald W. Meeker;Patent Agent, 924 East Ocean Front #E, Newport Beach, CA, 92661, US

(21) Appl. No.: 10/974,054

(22) Filed: Oct. 26, 2004

(51) Int. Cl. F16B 39/02

(52) U.S. Cl. 411/82

(57) ABSTRACT

A rigid box cover is hinged to a flatbed truck. Two hydraulic arms raise the cover to a vertical position at the back end of a flatbed trailer and lower it down over the cargo.

### BACKGROUND OF THE INVENTION

1. Field of the Invention

The present invention relates to rigid load covering devices and particularly to a tilt-up box-type cover for a flatbed truck, which is raised to a vertical position at the back end of the flatbed or lowered over the cargo by hydraulic arms.

2. Description of the Prior Art

Crushed vehicles or scrap metal bales may be loaded onto and removed from a flat bed truck by an overhead crane and magnet or grapple device. Once in place they are often strapped down haphazardly, creating nervous concern from any motorist who drives in a lane adjacent to the flatbed truck during transport of the scrap metal. Regulations now require that scrap on flatbed trucks be covered. Prior art devices lack a rigid secure means for covering scrap loads on flatbed trucks.

U.S. Pat. No. 5,681,074, issued Oct. 28, 1997 to Christensen, puts forth a trailer cover lift arm for assisting in opening a trailer cover and supporting the cover in an open position. The lift arm can include four elongate members each member having two ends pivotally coupled to define a member having parallelogram-like shape. First and second elongated gas springs can be disposed within the parallelogram member to assist an operator in opening, and supporting a trailer cover in an open position. The lift arm can be used to two-way tilt open a trailer cover.

U.S. Pat. No. 6,322,127, issued Nov. 27, 2001 and U.S. Pat. No. 5,890,757, issued Apr. 6, 1999 both to Masterson, claims a cover for a semi-trailer vehicle having a cargo support surface bordered by a pair of longitudinal edge regions. The cover has a roof and a pair of sidewalls forming a cargo receiving passage there between; each of the pair of sidewalls terminating at a longitudinal free edge region to expose the cargo receiving passage to the cargo support surface. A lifting arrangement lifts the cover between a first position above the cargo support surface and a second position in abutment with the cargo support surface. Couplings removably couple each of the longitudinal free edge regions to a corresponding longitudinal edge region.

U.S. Pat. No. 3,700,124, issued Oct. 24, 1972 to Lawrence, concerns a covered trailer for hauling wheeled loads, which has a ramp platform positional at the rear end of the trailer floor and removable therefrom. The ramp platform is insertable below the trailer floor on slide flanges where it is secured for travel.

U.S. Patent Application #20020084662, published Jul. 4, 2002 by Davis, provides a boat trailer that incorporates a cover for the trailer to enclose a stored boat upon the trailer. The cover is selectively raised by a winch mechanism to facilitate the loading and off loading of the boat from the trailer.

U.S. Pat. No. 6,186,580, issued Feb. 13, 2001 to Nothem, shows a support structure for supporting a canopy on a trailer. The support structure includes a first support arm having a first end pivotally connected to the canopy and a second pivotally connected to the first end of an intermediate support arm. The second end of the intermediate support arm is pivotally connected to the first end of a third support arm. The second end of the third support arm is pivotally connected to the trailer. First and second pneumatic springs are also provided. First pneumatic spring interconnects the first support arm and intermediate arm and the second pneumatic spring interconnects the intermediate support arm and the third support arm. The pneumatic springs assist an operator in lifting the canopy and provide sufficient force to maintain the canopy in an open position.

U.S. Pat. No. 6,488,329, issued Dec. 3, 2002 to Smith, provides an aerodynamic, lightweight, flexible material flatbed top for enclosing a flatbed of a wheeled vehicle. The horizontal frame structure of front and side rails may be expansible. Inverted U-shaped cover support poles run front to rear and are mounted in the rectangular horizontal frame. A flexible material is stretched or draped over the support poles and secured to the frame structure. Cooperating locking and pivoting pin assemblies for each corner of the trailer top cooperate with corner brackets located at the deck corners of the flatbed to secure the top to the flatbed and to permit alternating rotation about an axis located at the front of the top or an axis located at the rear of the top to gain access into the space covered by the top on the flatbed.

U.S. Pat. No. 6,527,336, issued Mar. 4, 2003 to Hernandez, discloses a pop-up utility trailer that includes a base frame with wheels attached and a cap. The cap is moveable between a first position in which the bottom of the cap is in sealing engagement with the base frame, and a second position vertically displaced from the first position. In the first position, the cap forms a sealed enclosure for protecting contents loaded onto the base frame. In the second position, the cap is raised to facilitate loading and unloading of the contents as well as to permit access to loaded contents from substantially any location around the perimeter of the trailer.

What is needed is a rigid cover for flatbed trucks that is easily lifted for loading and unloading.

### SUMMARY OF THE INVENTION

An object of the present invention is to provide a rigid box cover for flatbed trucks that is hinged across the back end of the flatbed and is easily lifted being pivoted by a hydraulic life to a vertical position uncovering the flatbed for loading and unloading.

A related object of the present invention is that it is easy to use with exterior rear mounted handle controls for hydraulic lift.

One more object of the present invention is that has rigid sealed cover with edges of rigid box overlapping the side edges of flatbed.

An additional object of the present invention is the box cover's lightweight aluminum panels and frame with tension cross-brace cables to maintain the structural integrity of the box cover while keeping its weight down to enable pivoting of the box cover by the hydraulic cylinders.

A further object of the present invention is an attached jack used to help support the box cover in the vertical position.

A contributory object of the present invention is the extended side edges of the box cover that overlap the side edges of a flatbed to seal the connection between the box cover and the flat bed ensuring vehicle scraps to be secure.

An added object of the present invention is the additional wooden rail that is attached to the sides of the frame to prevent the load from contacting the metal panels.

In brief, a rigid box, resembling a box top and sides of an enclosed rigid trailer of a tractor-trailer truck, is hinged to a back edge of a flatbed trailer. Two hydraulic arms are mounted in recessed cavities adjacent to the side edges of the flatbed near the rear of the flatbed. The two hydraulic arms are pivotally mounted to the flatbed and to bottom side edges of the box cover so that activating the hydraulic arms pivots the box cover up off the flatbed to a vertical position at the back edge of the flatbed for loading and unloading the flatbed, and pivot the box cover back down over the flatbed to cover the flatbed. Extended side edges of the box cover overlap the side edges of the flatbed to seal the connection between the box cover and the flatbed.

The box cover is formed of metal panels and structural metal frame members, preferably all lightweight metal such as aluminum, with cross-braced tension rods to maintain the structural integrity of the box cover and keep the weight as low as possible. Additional wooden rails are attached to the sides of the frame to prevent the load from contacting the metal panels. An attached jack is used to help support the box cover in the vertical position.

An advantage of the present invention is to provide a rigid box cover for flatbed trucks that is hinged to the flatbed for lifting out of the way to load and unload.

Another advantage of the present invention is that it is easy to use with exterior rear mounted handle controls for hydraulic lift.

An additional advantage of the present invention is that has rigid sealed cover.

One more advantage of the present invention is the box cover is lightweight to enable pivoting of the box cover by the hydraulic cylinders.

Yet another advantage of the present invention is the jack is attached to a back of the box cover to help support the box cover in the vertical position.

Still another advantage of the present invention is that it ensures scrap vehicles to be secure and covered on a flatbed.

A further advantage of the present invention is the additional wooden rails attached to prevent the load from contacting the metal panels.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the rigid box cover for flatbed trucks of the present invention shown partially elevated above a loaded flatbed truck with the hydraulic arms partially extended;

FIG. 2 is a partial side elevational view of the rigid box cover for flatbed trucks of FIG. 1 showing one of the hydraulic arms mounted in a recess in the flatbed with the hydraulic arm fully extended and the box cover in the full vertical position at the back end of the flatbed;

FIG. 3 is a side elevational view of the rigid box cover for flatbed trucks of FIG. 1 showing the box cover in the full vertical position (solid lines) and the full lowered position (dashed lines) on the loaded flatbed truck;

FIG. 3A is a partial sectional view of the rigid box cover for flatbed trucks of FIG. 1 showing a side edge of the box cover overlapping a side edge of the flatbed.

### BEST MODE FOR CARRYING OUT THE INVENTION

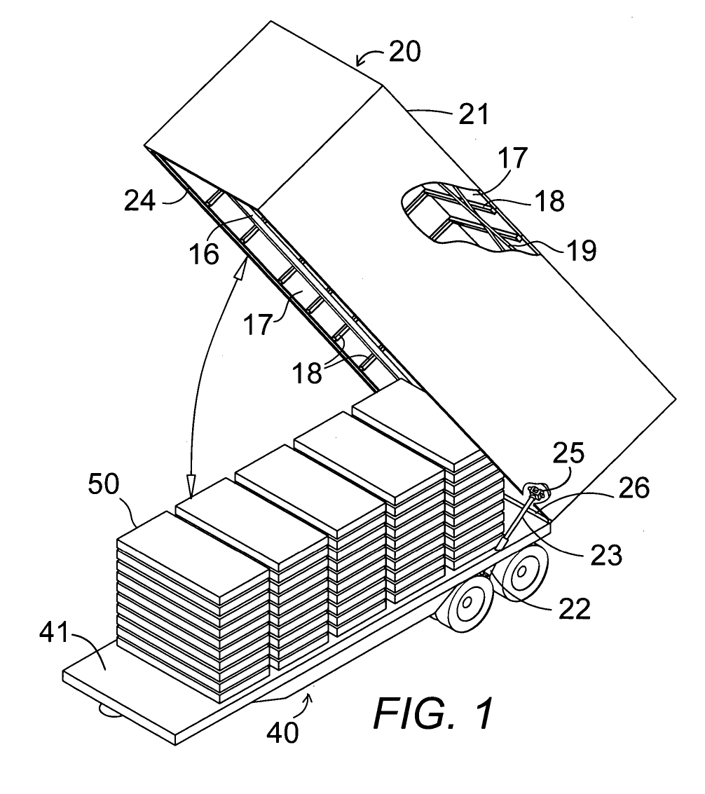

In FIGS. 1-3, a movable flatbed cover 20 covers a flatbed truck 40. The flatbed cover has a rigid box cover 21 that is similar in size and shape to a box top and sides of an enclosed rigid trailer of a tractor-trailer truck. The box cover attaches pivotally to a back edge of a flatbed 41 of a flatbed truck 40 by a hinge 26 at the edge of the back of the bottom of box cover.

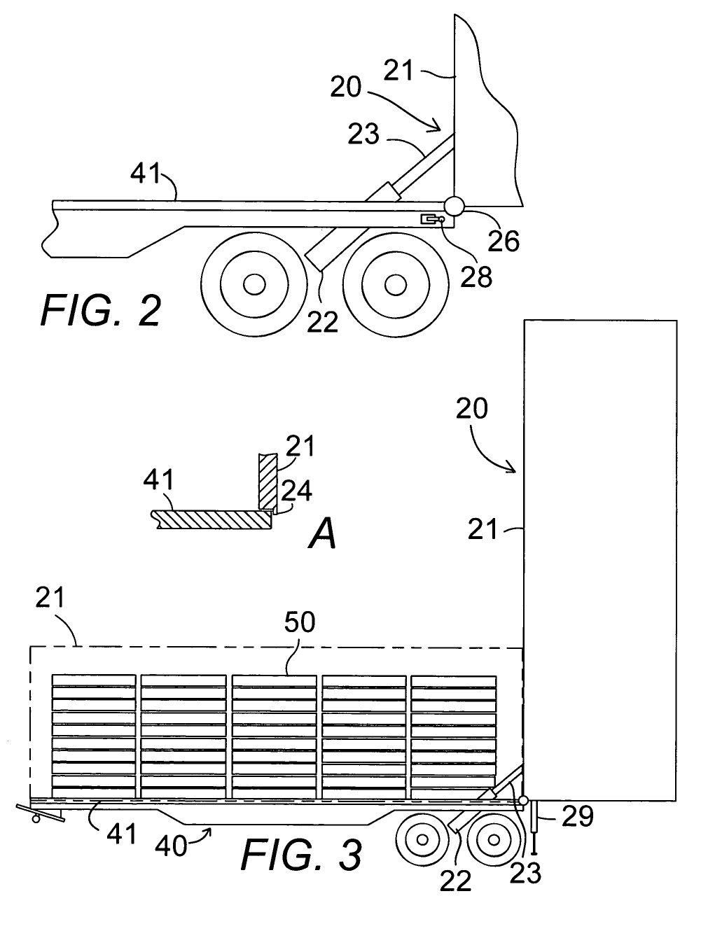

Two hydraulic cylinders 22 are mounted to a flatbed of the truck. Each of the hydraulic cylinders is mounted adjacent to a side edge of a flatbed near the rear of the flatbed with at least a portion of the hydraulic cylinder 22 that can extend below a top surface 41 of a flatbed. A movable hydraulic arm 23 extends from each of the hydraulic cylinders 22 pivotally mounted by a structural steel pivot 25 to an edge at the bottom side of the box cover. The hydraulic arms 23 are adapted to extend out of the cylinders 22 to pivot the box cover 21 up off a flatbed 41 to a vertical position (shown in FIG. 2 and in solid lines FIG. 3) at the back edge of the flat bed for loading and unloading a flatbed. The hydraulic arms 23 retract into the cylinders 22 to pivot the box cover 21 back down over the flatbed 41 to cover it (shown in dashed lines in FIG. 3) with a load 50, such as crushed vehicles on the flatbed 41. A hydraulic cylinder control arm 28 (shown in FIG. 2) is mounted on the flatbed for controlling extension and retraction of the hydraulic arms 23.

In FIG. 3A, the movable flatbed has extended side edges 24 of the box cover adapted to overlap side edges of the flatbed 41 to seal a connection between the box cover 21 and the flatbed 41.

In FIG. 1, the box cover comprise metal panels 17 that form a top and sides of the box cover and structural metal frame members 18 that support the metal panels and cross-braced tension rods 19 to maintain the structural integrity of the box cover 21.

The panels 17 and structural frame members 18 of the box cover 21 are preferably formed of lightweight aluminum to enable the hydraulic arms to light the box cover easily.

The box cover 21 has a jack 29 (shown in FIG. 3) attached to a back of the box cover that is able to extend from the back of the box cover to a ground surface to help support the box cover in the vertical position.

In use, an operator uses the control lever 28 on the side of the flatbed 41 to extend the hydraulic arms 23 to raise the box cover 21 to a vertical position, as shown in FIG. 2 and in solid lines in FIG. 3. The jack 29 can be attached to pivot down or be lowered down to the ground and adjusted by the operator. The flatbed 41 is loaded with a load 50, such as crushed vehicles, and the control is used to retract the hydraulic arms 23 to lower the box cover 21 over the load 50 on the flatbed 21.

It is understood that the preceding description is given merely by way of illustration and not in limitation of the invention and that various modifications may be made thereto without departing from the spirit of the invention as claimed.

What is claimed is:

1. A movable flatbed cover for covering a flatbed truck, the flatbed cover comprising:
a rigid box cover, of a size and shape resembling a box top and sides of an enclosed rigid trailer of a tractor trailer truck, the box cover pivotally attachable to a back edge of a flatbed of a truck by a hinge at a back bottom edge of the box cover;
two hydraulic cylinders mountable to a flatbed of a truck, each of the hydraulic cylinders mountable adjacent to a side edge of a flatbed near a rear of a flatbed with at least a portion of the hydraulic cylinder extending below a top surface of a flatbed, a movable hydraulic arm extending from each of the hydraulic cylinders pivotally mounted to a bottom side edge of the box cover, the hydraulic arms adapted to extend out of the cylinders to pivot the box cover up off a flatbed to a vertical position at a back edge of a flatbed for loading and unloading a flatbed, and adapted to retract into the cylinders to pivot the box cover back down over a flatbed to cover a flatbed
a control mountable on a flatbed for controlling extension and retraction of the hydraulic arms.

2. The movable flatbed cover of claim 1 further comprising extended side edges of the box cover adapted to overlap side edges of a flatbed to seal a connection between the box cover and a flatbed.

3. The movable flatbed cover of claim 1 wherein the box cover comprises metal panels forming a top and sides of the box cover and structural metal frame members supporting the metal panels and cross-braced tension rods to maintain the structural integrity of the box cover.

4. The movable flatbed cover of claim 3 wherein the panels and structural frame members are formed of aluminum.

5. The movable flatbed cover of claim 1 wherein the box cover further comprises wooden rails attached to interior sides of the frame members to prevent a load on a flatbed from contacting the metal panels.

6. The movable flatbed cover of claim 1 further comprising a jack attached to a back of the box cover, the jack adapted to extend from the back of the box cover to a ground surface to help support the box cover in the vertical position.

7. The movable flatbed cover of claim 1 wherein the control comprises a hydraulic cylinder control mountable on an edge of a flatbed.
